(19) United States
(12) Patent Application Publication
(10) Pub. No.: US 2011/0195712 A1
(43) Pub. Date: Aug. 11, 2011

(54) WIRELESS NETWORK FREQUENCY SCANNING

(76) Inventors: Christian MUCKE, Petershausen (DE); Bernd Kemmer, Eichenau (DE); Hans Friedrich, Nuemberg (DE); Uwe Stadelmann, Fuerth (DE); Mark Jeffrey, Munich (DE)

(21) Appl. No.: 12/701,478

(22) Filed: Feb. 5, 2010

(51) Int. Cl. H04W 48/16

(52) U.S. Cl. 455/434

(57) ABSTRACT

Disclosed is a frequency scanning method that employs a number of frequency sets that may be scanned consecutively, according to a fixed delay or interval, to discover a frequency that may be used to obtain wireless communication service. In one implementation, any number of these sets may be scanned before a wireless device performs a scan of a full set of frequencies that may be available to the wireless device.

### BACKGROUND

There are a significant number of frequencies available for communication in mobile communication systems. This large number of frequencies has increased the amount of time needed for a user equipment (UE), such as a mobile phone or other remote terminal, to locate a suitable wireless network during frequency scanning, for instance during power-up and loss-of-service scenarios.

Mobile communication systems include time-division multiple access (TDMA) systems, such as cellular radio telephone systems that comply with the global system for mobile communications (GSM) telecommunication standard and its enhancements like GSM/EDGE, and code-division multiple access (CDMA) systems, such as cellular radio telephone systems that comply with the IS-95, cdma2000, and wideband CDMA (WCDMA) telecommunication standards. Digital communication systems also include combined TDMA and CDMA systems, such as cellular radio telephone systems that comply with the universal mobile telecommunications system (UMTS) standard, which specifies a third generation (3G) mobile system being developed by the European Telecommunications Standards Institute within the International Telecommunication Union's IMT-2000 framework. The Third Generation Partnership Project (3GPP) promulgates the UMTS and WCDMA standards.

3G mobile communication systems based on WCDMA as the radio access technology (RAT) are being deployed all over the world. High-speed downlink packet access (HSDPA) is an evolution of WCDMA that provides higher bit rates by using higher order modulation, multiple spreading codes, and downlink-channel feedback information. Another evolution of WCDMA is Enhanced Uplink (EUL), or High-Speed Uplink Packet Access (HSUPA), that enables high-rate packet data to be sent in the reverse, or uplink, direction. New RATs are being considered for evolved-3G and fourth generation (4G) communication systems, although the structure of and functions carried out in such systems will generally be similar to those of earlier systems. In particular, orthogonal frequency division multiplexing is under consideration for evolved 3G and 4G systems.

Current and future communication systems may require a UE to search for its last registered Public Land Mobile Network (RPLMN) in every supported radio access technology and frequency bands associated therewith before attempting to register on another PLMN. The foregoing is also known in the wireless industry as a full band scan. Today, such a full scan already takes a fairly long time in a dense or complex radio environment, which will be further exacerbated when additional frequency bands are introduced and more access technologies are integrated.

In most scenarios a full band scan can give rise to inefficient utilization of radio resources. More specifically, performing a full band scan of frequencies associated with a last RPLMN may consume significant processing power and battery resources. Also, the time to perform a full scan may be so long that the radio environment may have changed significantly between the time when the scan was started and the time the UE device decides to select a frequency associated with a new PLMN. As a result, by the time the UE decides to select a frequency associated with a new wireless network, a frequency associated with a higher priority wireless network may have appeared again.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different instances in the description and the figures may indicate similar or identical items.

FIG. 1 is a diagram of a communication network that may be in communication with a user equipment (UE) that implements wireless network frequency scanning according to the implementations described herein.

FIG. 2 is a diagram of a wireless device or apparatus that may be provisioned to frequency scan according to the implementations described herein.

FIG. 3 is a flow diagram of a wireless network scanning procedure to select a frequency associated with a wireless network provider in order to obtain wireless communication service.

### DETAILED DESCRIPTION

### Overview

The following description describes implementations related to wireless network frequency scanning associated with a user equipment (UE) or wireless device. In one implementation, the UE, after a loss of service scenario, searches a number of stored frequencies that UE was recently interfaced with or otherwise had the opportunity to register on in order to obtain access to an associated wireless network provider and the wireless communication service provided thereby. In another implementation, the UE, after a loss of service scenario, searches frequencies associated with a particular radio access technology (RAT) in order to obtain access to an associated wireless network provider. In another implementation, the UE, after a loss of service scenario, searches one or more particular frequency bands based on a duration of the loss of service. In yet another implementation, the UE, after a loss of service scenario, uses a plurality of the foregoing wireless network frequency scanning techniques before executing a full frequency scan. In yet another implementation, the UE, after a loss of service scenario, uses any of the foregoing wireless network frequency scanning techniques at least a plurality of times. Another implementation may use the foregoing repeated wireless network frequency scanning techniques by introducing a delay or a fixed time interval between each wireless network frequency scanning attempt. In yet another implementation, the UE, after a loss of service scenario, uses a plurality of the foregoing wireless network frequency scanning techniques before executing a full frequency scan.

### Exemplary Communication Network

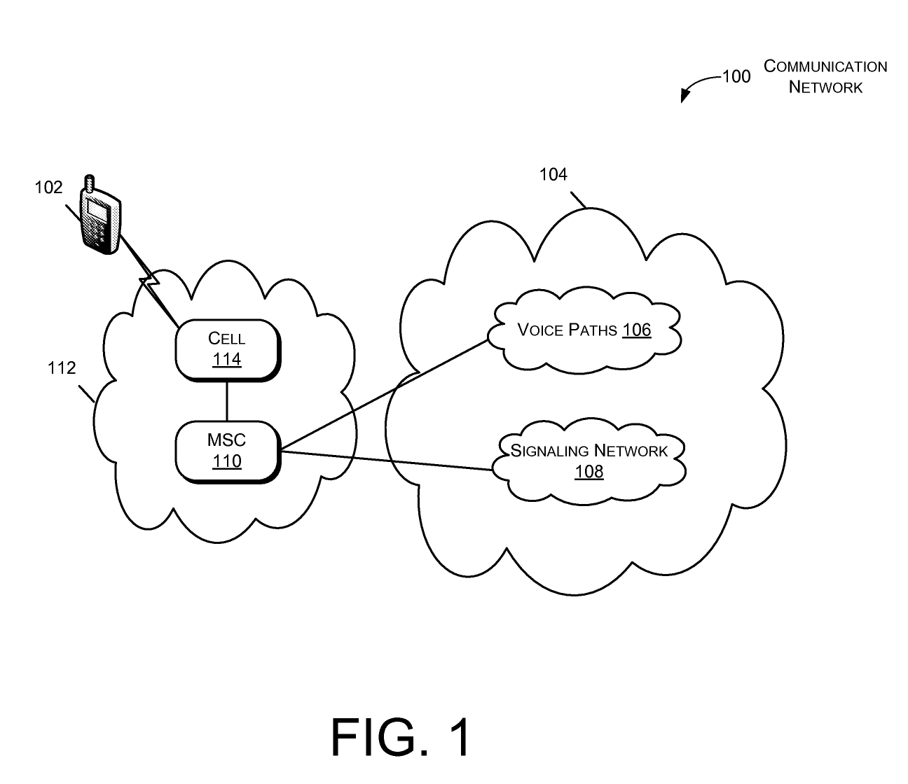

FIG. 1 is a diagram of a communication network 100 that may be in communication with a UE 102 that implements wireless network frequency scanning according to the implementations described herein. The communication network 100 may include a Publicly Switched Telephone Network (PSTN) 104. The PSTN 104 may generally include a plurality of voice paths 106 and a signaling network 108 that handles data communication. Other components, which are known, such as signal transfer points, tandem switching systems, local switching systems, selective routers, and the like, are not illustrated in the communication network 100 of FIG. 1.

A mobile switching center (MSC) 110 may be connected to the PSTN 104 via both the voice paths 106 and signaling network 108. The MSC 110 may be part of a PLMN 112. For simplicity, a single PLMN 112 is illustrated. However, there may be multiple PLMNs 112 in a given geographical area, and any one of the multiple PLMNs 112 may be utilized by the UE 102. In general, the UE 102 and the PLMNs 112 may be utilized within any number of wireless communication systems including, but not limited to, time-division multiple access (TDMA) systems, such as cellular radio telephone systems that comply with the global system for mobile communications (GSM) telecommunication standard and its enhancements like GSM/EDGE, and code-division multiple access (CDMA) systems, such as cellular radio telephone systems that comply with the IS-95, cdma2000, and wideband CDMA (WCDMA) telecommunication standards; and digital communication systems also include combined TDMA and CDMA systems, such as cellular radio telephone systems that comply with the universal mobile telecommunications system (UMTS) standard, which specifies a third generation (3G) mobile system being developed by the European Telecommunications Standards Institute within the International Telecommunication Union's IMT-2000 framework. Such wireless communication systems may implement high-speed downlink packet access (HSDPA), which is an evolution of WCDMA that provides higher bit rates by using higher order modulation, multiple spreading codes, and downlink-channel feedback information. Another evolution of WCDMA is Enhanced Uplink (EUL), or High-Speed Uplink Packet Access (HSUPA), that enables high-rate packet data to be sent in the reverse, or uplink, direction. Furthermore, such wireless communication systems may include new RATs that are being considered for evolved 3G and fourth generation (4G) communication systems.

The MSC 110 may be connected to a plurality of cell sites, represented herein as a cell site 114, either directly or via base station controllers (not illustrated) associated with the cell site 114. Each cell site 114 supports telephony functions for a plurality of mobile communication devices, represented by the UE 102 that implements a wireless device or apparatus that may implement wireless network frequency scanning according to the implementations described herein. More specifically, each cell site 114 may broadcast one or more frequencies that a wireless device may interface with or “camp” on to obtain wireless communication service. These one or more frequencies broadcast by each cell site 114 may be associated with a particular frequency band and RAT. For example, the frequency bands that are predominantly used in North America are 850 MHz and 1900 MHz frequency bands. Elsewhere in the world, in particular in Europe, 900 MHz and 1800 MHz are the two bands primarily in use. A wireless device may be designed to support multiple frequency bands, including bands in both the European and North American frequency plans. For example, a wireless device may be designed to communicate on 900 MHz, 1800 MHz, and 1900 MHz bands. When outside of North America, such a device must select between 900 MHz and 1800 MHz bands, whereas inside of North America, the device operates upon the 1900 MHz band. Example 2G RATs include GSM, TDMA, PDC; example 3G RATs include WCDMA and CDMA 2000; and example 4G RATs includes LTE Advanced.

### Exemplary Wireless Device

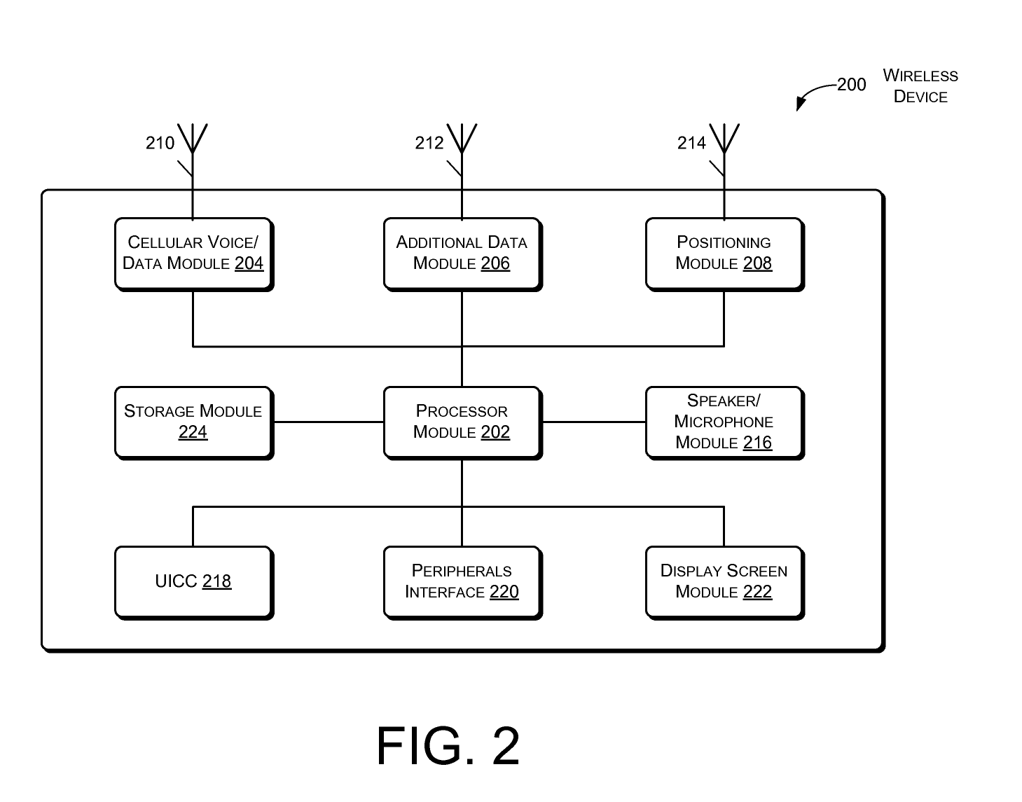

FIG. 2 is a diagram of a wireless device, UE or apparatus 200 that may implement wireless network frequency scanning according to the implementations described herein. The wireless device or apparatus 200 may include a processor module 202 coupled to a plurality of wireless modules that enable the wireless device or apparatus 200 to communicate wirelessly. The wireless modules may include a cellular voice/data module 204, an additional data module 206 (e.g., Bluetooth module), and a positioning module 208 (e.g., GPS module). The wireless device or apparatus 200 is not limited to the illustrated wireless modules. Each of the wireless modules is coupled to an antenna 210, 212 and 214, respectively. Although the antennas 210, 212 and 214 are shown as separate antennas, a single unitary antenna may also be used and coupled to the modules 204-208.

The processor module 202 may also be coupled to a speaker/microphone module 216, an integrated circuit card (UICC) 218 loaded with a subscriber identity module (SIM) or a universal subscriber identity module (USIM) 218, a peripherals interface 220 and a display module 222. Furthermore, the processor module 202 may be coupled to a storage module 224. The storage module 224 may be a nonvolatile storage or volatile storage. The UICC 218 and/or the storage module 224 may include a comprehensive network credential list. Alternatively or in addition, the wireless device or apparatus 200 may store a comprehensive network credential list in another storage associated therewith. Each network credential in the list may be associated with a wireless communication network that may be used by the wireless device or apparatus 200. In one implementation, each network credential is a PLMN entry.

The wireless device or apparatus 200 may be configured to transmit and receive voice and data communications to and from the MSC 110 via the cell site 112. Such communications may include voice communications directly from a user and via the speaker/microphone module 216, data generated from peripherals coupled to the peripherals interface 220 and received via the display screen module 222, and positioning information from the positioning module 208.

Depending on the targeted implementation, the wireless device or apparatus 200, or parts thereof, may be an integral part of a larger system, such as a vehicle. Alternatively, the wireless device or apparatus 200, or parts thereof, may be a separate component included in a device such as a portable cellular or personal communication system (PCS), a pager, or a hand-held computing device such as a personal digital assistant (PDA).

Each of the wireless modules 204-208 includes a transmitter to transmit and encode voice and data messages using antennas 210-214, respectively, via an over-the-air protocol such as CDMA, WCDMA, GSM, TDMA, or the like. The wireless modules 204-208 may also be configured to transmit by other wireless communications, such as satellite communications. Each of the wireless modules 204-208 also includes a receiver to receive and decode voice and data messages from the cell site 112 and the MSC 110, or any other component associated with the communication network 100. Such received voice and data messages may be received via an over-the-air protocol such as CDMA, WCDMA, GSM, TDMA, or the like. The wireless modules 204-208 may also be configured to receive other wireless communications, such as satellite communications. The transmitters and receivers may be integrated transceiver devices.

Each network credential (e.g., PLMN) in the network credential list stored in the UICC 218 and/or the storage module 224 may be supported by a plurality of cells or base stations. The cells associated with a given network credential may support one or more RATs and the frequencies associated with those one or more RATs. For example, one entity or wireless network provider associated with a first network credential may support frequencies associated with WCDMA, where another entity or wireless network provider associated with a second network credential may support frequencies associated with GSM. Although WCDMA and GSM are mentioned specifically in the foregoing, the wireless network frequency scanning implementations described herein may be used in connection with entities or wireless network providers that offer other RATs. Such other RATs include TDMA, CDMA, combined TDMA and CDMA, and evolved 3G and 4G systems.

### Exemplary Procedures

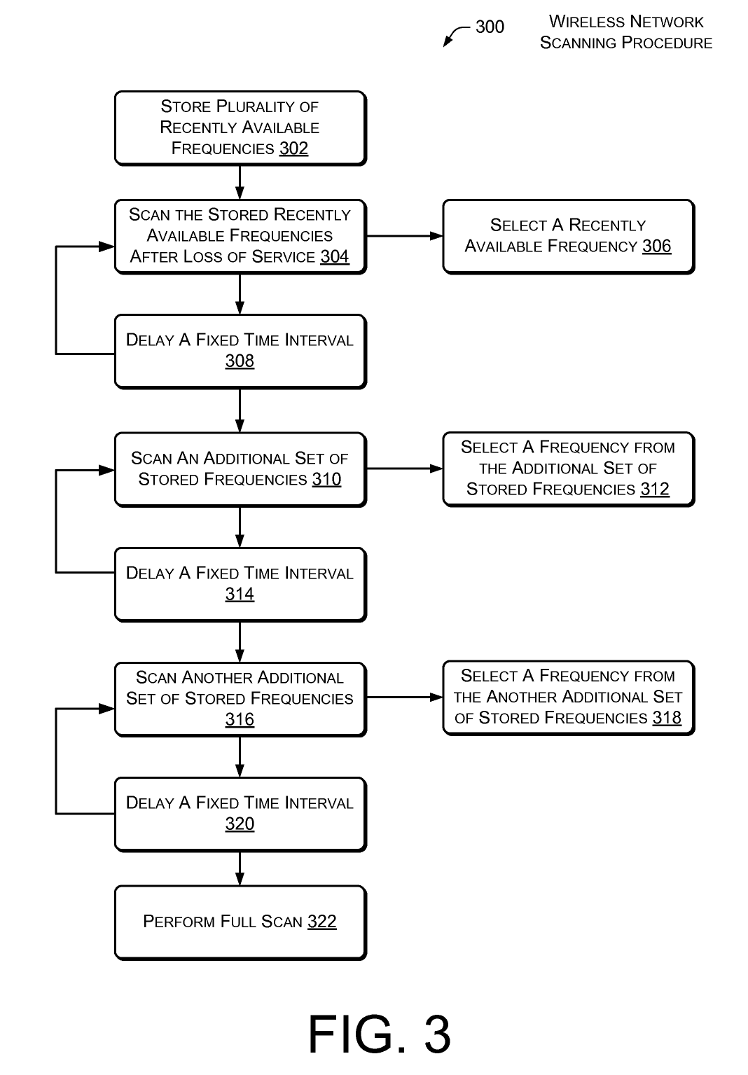

FIG. 3 is a flow diagram of a wireless network scanning procedure 300 to select a frequency associated with a wireless network provider in order to obtain wireless communication service. Reference may be made to FIGS. 1-2 to aid the discussion of wireless network scanning procedure. However, the wireless network scanning procedure is compatible with wireless networks and devices other than those illustrated and discussed herein.

Specifics of exemplary procedures are described below. However, it should be understood that certain acts need not be performed in the order described, and may be modified, and/or may be omitted entirely, depending on the circumstances. Moreover, the acts described may be implemented and executed by a computer, processor or other computing device, such as a wireless device, based on instructions stored on one or more computer-readable storage media. The computer-readable storage media can be any available media that can be accessed by a computing device to implement the instructions stored thereon.

At Act 302, a wireless device, such as the UE 102, stores a plurality of recently available wireless communication network frequencies in a physical storage associated therewith. The recently available wireless communication network frequencies may be frequencies that the wireless device used to obtain wireless communication service during a predetermined timeframe. Alternatively, or in addition, such recently available wireless communication network frequencies may include frequencies that were available to the wireless device, in the same timeframe, but were not selected by the wireless device in order to obtain wireless communication service. In one implementation, the number of recently available wireless communication network frequencies stored in the physical storage is limited to a predetermined maximum number (e.g., ten (10) recently available wireless communication network frequencies). Once the predetermined maximum number is reached, a processor may eliminate the oldest stored recently available wireless communication network frequency once the wireless device uses a new frequency to obtain wireless communication service or determines a new frequency is available to the wireless device. Upon eliminating the oldest stored recently available wireless communication frequency, the processor may enable storage of the new frequency. In another implementation, the stored plurality of recently available wireless communication network frequencies are stored in an ordered manner from the frequency that has a highest determined received signal strength to the frequency that has the lowest determined received signal strength.

At Act 304, the wireless device scans the recently available wireless communication network frequencies after recovering from a loss of service scenario. Such a loss of service scenario may occur when the wireless device loses power, drops a current communication session (e.g., when passing through an area with “no service”), or the like. At Act 306, if one or more of the recently available wireless communication network frequencies is available to the wireless device, the device may start the conventional process of establishing a communication session on a chosen frequency. In one implementation, the wireless device may select the recently available frequency that has the highest determined received signal strength. If the wireless device selects one of the stored recently available wireless communication network frequencies, the process illustrated in FIG. 3 terminates at Act 306. Otherwise, the procedure moves to Act 308.

At Act 308, the wireless device may delay a fixed time interval before beginning a next frequency scanning procedure. In one implementation, the wireless device always uses the fixed time interval between consecutive scans of stored frequency sets. In one implementation, after the delay, the wireless device may repeat the scan of at least some of the recently available wireless communication network frequencies scanned in Act 304. In another implementation, after the delay, the wireless device may repeat the scan of all of the recently available wireless communication network frequencies scanned in Act 304. The wireless device may repeat the scanning of some or all of the recently available wireless communication network frequencies a predetermined number of times, until a timer event occurs, or the like. If one or more of the recently available wireless communication network frequencies is available to the wireless device before the predetermined number of times is reached, the timer event occurs, or the like, the device may start the conventional process of establishing a communication session on a chosen frequency at Act 306.

At Act 310, the wireless device may initiate a scan of an additional set of frequencies stored in the wireless device. In one implementation, the additional set of frequencies may include one or more frequencies already scanned in Act 304. And in one implementation, the additional set of frequencies may be limited to frequencies associated with a last registered PLMN. In another implementation, the additional set of frequencies may be limited to frequencies associated with a last registered PLMN and a particular frequency band, or a predetermined number of frequency bands. In another implementation, the additional set of frequencies may be limited to frequencies associated with a last registered PLMN and a particular RAT, or a predetermined number of particular RATs. In another implementation, the additional set of frequencies may be limited to frequencies associated with a single frequency band, or a predetermined number of frequency bands. In yet another implementation, the additional set of frequencies may be limited to a single RAT, or a predetermined number of RATs. In yet another implementation, the additional set of frequencies may include frequencies that are not stored in the wireless device. In yet another implementation, the additional set of frequencies may include specific frequencies associated with one or more frequency bands that may or may not be stored in the wireless device. In another implementation, the additional set of frequencies may be limited to one or more frequency bands, PLMNs, and/or RATs that are likely active in an estimated geographical area.

The geographical area may be estimated based on geographical radius information generated based on a duration of the loss of service. The wireless device may include a processor, such as the processor module 202, that executes a timer instruction set when the loss of service occurs. Alternatively, the processor module 202 may enable a hardware timing device associated with the wireless device to track the elapsed time. A center of the generated radius information may be an estimated or known position of the wireless device obtained before the wireless device lost wireless communication service. The geographical radius information may be enhanced by considering an estimated velocity of the wireless device. That is, knowing the estimated velocity of the wireless device, coupled with the elapsed time and center information, may enable the determination of highly accurate geographical radius information. As those of ordinary skill in the art appreciate, distance information and time may be used to calculate speed or average speed. The wireless devices described herein are functionally capable of determining distance information using position information and time using integrated capabilities of the devices.

At Act 312, if one or more of the frequencies associated with the additional set of frequencies is available to the wireless device, the device may start the conventional process of establishing a communication session on a chosen frequency. In one implementation, the wireless device may select an available frequency that has the highest determined received signal strength. If the wireless device selects one of the frequencies associated with the additional set of frequencies, the process illustrated in FIG. 3 terminates at Act 312. Otherwise, the procedure 300 moves to Act 314.

At Act 314 the wireless device may delay a fixed time interval before beginning a next frequency scanning procedure. In one implementation, the wireless device always uses the fixed time interval between consecutive scans of frequency sets. In one implementation, after the delay, the wireless device may repeat the scan of at least some of the frequencies of the additional set of frequencies scanned in Act 310. In another implementation, after the delay, the wireless device may repeat the scan of all of the frequencies of the additional set of frequencies scanned in Act 310. The wireless device may repeat the scanning of some or all of the frequencies of the additional set of frequencies a predetermined number of times, until a timer event occurs, or the like. If one or more of the frequencies of additional set of frequencies is available to the wireless device before the predetermined number of times is reached, the timer event occurs, or the like, the device may start the conventional process of establishing a communication session on a chosen frequency at Act 312.

At Act 316, the wireless device may initiate a scan of another additional set of frequencies stored in the wireless device. In one implementation, the additional set of frequencies may include one or more frequencies already scanned in Acts 304 and 310. In another implementation, the another additional set of frequencies may be limited to frequencies associated with a last registered PLMN. In another implementation, the another additional set of frequencies may be limited to frequencies associated with a last registered PLMN and a particular frequency band, or a predetermined number of frequency bands. In another implementation, the another additional set of frequencies may be limited to frequencies associated with a last registered PLMN and a particular RAT, or a predetermined number of particular RATs. In another implementation, the another additional set of frequencies may be limited to frequencies associated with a single frequency band, or a predetermined number of frequency bands. In yet another implementation, the another additional set of frequencies may be limited to a single RAT, or a predetermined number of RATs. In another implementation, the another additional set of frequencies may be limited to one or more frequency bands, PLMNs, and/or RATs that are likely active in an estimated geographical area. Estimating the geographical area may be possible using the procedure discussed hereinabove. In yet another implementation, the another additional set of frequencies may include frequencies that are not stored in the wireless device. In yet another implementation, the another additional set of frequencies may include specific frequencies associated with one or more frequency bands that may or may not be stored in the wireless device.

At Act 318, if one or more of the frequencies associated with the another additional set of frequencies is available to the wireless device, the device may start the conventional process of establishing a communication session on a chosen frequency. In one implementation, the wireless device may select an available frequency that has the highest determined received signal strength. If the wireless device selects one of the frequencies associated with the another additional set of frequencies, the process illustrated in FIG. 3 terminates at Act 318. Otherwise, the procedure 300 moves to Act 320.

At Act 320 the wireless device may delay a fixed time interval before beginning a next frequency scanning procedure. In one implementation, the wireless device always uses the fixed time interval between consecutive scans of frequency sets. In one implementation, after the delay, the wireless device may repeat the scan of at least some of the frequencies of the another additional set of frequencies scanned in Act 316. In another implementation, after the delay, the wireless device may repeat the scan of all of the frequencies of the another additional set of frequencies scanned in Act 316. The wireless device may repeat the scanning of some or all of the frequencies of the another additional set of frequencies a predetermined number of times, until a timer event occurs, or the like. If one or more of the frequencies of the another additional set of frequencies is available to the wireless device before the predetermined number of times is reached, the timer event occurs, or the like, the device may start the conventional process of establishing a communication session on a chosen frequency at Act 318. Otherwise, at Act 322, the wireless device may perform a conventional full scan of a full set of frequencies available to the wireless communication device.

In the foregoing, Acts 304, 310 and 316 may be repeated until all frequency sets are exhausted before starting a full scan in Act 322. In an alternative implementation, only a plurality of the frequency sets are scanned before the wireless device performs the full scan. If a frequency is not found after the full scan, a different plurality of frequency sets may be scanned before starting another full scan. In another exemplary implementation, a plurality of frequency sets are scanned before the wireless device performs the full scan. If a frequency is not found after the full scan, the same plurality of frequency sets are scanned before starting another full scan. If a frequency is still not found after the another full scan, a different plurality of frequency sets are scanned before starting another full scan. It should be appreciated other scanning combinations are also possible in accordance with the implementations disclosed herein.

In one particular implementation, a wireless device performs a scan of a set of recently available frequencies. This is a short scan (SS) that includes a finite number of frequencies (e.g., ten frequencies). If the wireless device does not find a frequency, a larger number of frequencies is scanned (e.g., frequencies associated with a band, RAT, RATs, or a convention full scan of all known frequencies). This is a long scan (LS), which is longer than the SS. If the wireless device does not find a frequency in the LS, the wireless device performs second SS. The second SS may include the same finite number of frequencies in the first SS, or different frequencies. However, the duration of the second SS should be about the same as the duration of the first SS. If the wireless device does not find a frequency in the second SS, the wireless device performs a third SS. Again, the third SS may include the same finite number of frequencies in the first and second SS, or different frequencies. However, the duration of the third SS should be about the same as the duration of the first and second SS. If the wireless device does not find a frequency, a second LS is performed. The second LS may include the same frequencies in the first LS, or different frequencies. However, the duration of the second LS should be about the same as the duration of the first LS. If the wireless device does not find a frequency in the second LS, the wireless device performs a forth SS. The pattern that develops may be: SS-LS-SS-SS-LS-SS-SS-SS-LS . . . . In one implementation, a delay between each scan is fixed. And in one implementation, the maximum number of short scans and total delay that may occur between long scans may not exceed a duration of the longest LS.

For the purposes of this disclosure and the claims that follow, the terms “coupled” and “connected” have been used to describe how various elements interface. Such described interfacing of various elements may be either direct or indirect. Although the subject matter has been described in language specific to structural features and/or methodological acts, it is to be understood that the subject matter defined in the appended claims is not necessarily limited to the specific features or acts described. Rather, the specific features and acts are disclosed as preferred forms of implementing the claims. The specific features and acts described in this disclosure and variations of these specific features and acts may be implemented separately or may be combined.

1. A method, comprising:
storing in physical storage a plurality of recently available wireless communication network frequencies, the recently available wireless communication network frequencies useable to obtain wireless communication service; and
scanning the stored plurality of recently available wireless communication network frequencies after a loss of service scenario linked to a wireless communication device;
delaying a predetermined period after the scanning act; and
scanning another plurality of wireless communication network frequencies after delaying the predetermined period.

2. The method according to claim 1, wherein the storing act stores a predetermined maximum of recently available wireless communication network frequencies in the physical storage.

3. The method according to claim 2, wherein the storing act includes, once the predetermined maximum is reached, eliminating an oldest of the stored recently available wireless communication network frequencies when a new available wireless communication network frequency is detected.

4. The method according to claim 1, further comprising selecting one of the stored plurality of recently available wireless communication network frequencies to obtain wireless communication service, the selected one of the stored plurality of recently available wireless communication network frequencies having a highest received signal strength.

5. The method according to claim 1, further comprising determining that none of the stored plurality of recently available wireless communication network frequencies is available; and the scanning act scans the another plurality of wireless communication network frequencies that includes one or more frequencies of the a plurality of recently available wireless communication network frequencies, or a set of frequencies limited to a single frequency band associated with a last registered public land mobile network (PLMN).

6. The method according to claim 1, further comprising determining that none of the stored plurality of recently available wireless communication network frequencies is available; and the scanning act scans the another plurality of wireless communication network frequencies that includes a set of frequencies limited to one or more frequency bands associated with an estimated geographical area.

7. The method according to claim 1, further comprising determining that none of the stored plurality of recently available wireless communication network frequencies is available; and the scanning act scans the another plurality of wireless communication network frequencies that includes a full set of frequencies available to the wireless communication device.

8. A method, comprising:
determining that a wireless communication device has lost wireless communication service; and
scanning a plurality of frequencies to obtain wireless communication service, the plurality of frequencies divided between at least a plurality of frequency groups, a time interval to start scanning frequencies associated with a second of the plurality of frequency groups after completing a scan of a first of plurality of the frequency groups being fixed.

9. The method according to claim 8, wherein each of the plurality of frequency groups includes a subset of frequencies associated with a comprehensive frequency list stored in the wireless communication device.

10. The method according to claim 8, wherein the first of the plurality of frequency groups includes a plurality of recently available wireless communication network frequencies, the recently available wireless communication network frequencies useable to obtain wireless communication service and being a subset of frequencies associated with a comprehensive frequency list.

11. The method according to claim 10, wherein the second of the plurality of frequency groups includes at least one wireless communication network frequency of the plurality of recently available wireless communication network frequencies, or a plurality of frequencies associated with a single frequency band and being a subset of the frequencies associated with the comprehensive frequency list stored in the wireless communication device.

12. The method according to claim 10, wherein the second of the plurality of frequency groups includes a plurality of frequencies associated with at least one frequency band of a single radio access technology (RAT).

13. An apparatus, comprising:
a storage configured to store a plurality recently available wireless communication network frequencies, the recently available wireless communication network frequencies useable to obtain wireless communication service; and
a processor coupled to the storage, the processor configured to
scan the stored plurality of recently available wireless communication network frequencies after a loss of service scenario linked to a wireless communication device, and
delay a predetermined period after the scan, the predetermined period for use between each scan of frequencies.

14. The method according to claim 13, wherein the storage is configured to store a predetermined maximum of recently available wireless communication network frequencies.

15. The method according to claim 14, wherein the processor is further configured to eliminate an oldest of the stored recently available wireless communication network frequencies when a new available wireless communication network frequency is detected.

16. The method according to claim 13, wherein the processor is further configured to select one of the stored plurality of recently available wireless communication network frequencies to obtain wireless communication service, the selected one of the stored plurality of recently available wireless communication network frequencies having a highest received signal strength.

17. The method according to claim 13, wherein the processor is further configured to determine that none of the stored plurality of recently available wireless communication network frequencies is available, initiate the predetermined delay after the determination, and scan a set of frequencies after the predetermined delay.

18. The method according to claim 13, wherein the processor is further configured to determine that none of the stored plurality of recently available wireless communication network frequencies is available, and repeat the scan the stored plurality of recently available wireless communication network frequencies after the predetermined delay.

19. The method according to claim 13, wherein the processor is further configured to determine that none of the stored plurality of recently available wireless communication network frequencies is available, and scan a full set of frequencies available to the wireless communication device after the predetermined delay.

20. A method, comprising:
determining that a wireless communication device has lost wireless communication service; and
scanning a plurality of frequencies to obtain wireless communication service, each of the plurality of frequencies associated with one or more frequency sets;
the act of scanning a plurality of frequencies including:
scanning at least a plurality of the one or more frequency sets, wherein a predetermined delay is inserted between each scanned frequency set of the at least a plurality of the one or more frequency sets, and
scanning at least another plurality of the one or more frequency sets, wherein the same predetermined delay is inserted between each scanned frequency set of the at least another plurality of the one or more frequency sets.

21. The method according to claim 20, further comprising delaying the predetermined delay after the scanning act, and scanning a frequency set that includes all frequencies available to the wireless communication device.
